(19) United States
(12) Patent Application Publication
(10) Pub. No.: US 2003/0014506 A1
(43) Pub. Date: Jan. 16, 2003

(54) MANAGEMENT OF A NETWORK ELEMENT USING MANAGED OBJECTS IN A DIGITAL COMMUNICATIONS NETWORK

(76) Inventors: JORG SCHABERNACK, VAIHINGEN (DE); MONIKA BANZHAF, STUTTGART (DE)

Correspondence Address: SUGHRUE MION ZINN MACPEAK & SEAS PLLC, 2100 PENNSYLVANIA AVENUE N W, WASHINGTON, DC, 200373213

(21) Appl. No.: 09/328,893

(22) Filed: Jun. 9, 1999

(30) Foreign Application Priority Data
Jun. 12, 1998 (DE) 19826088.1

(51) Int. Cl. G06F 15/173

(52) U.S. Cl. 709/223

(57) ABSTRACT

Network elements of a digital communications network, for example of an SDH network (SDH=Synchronous Digital Hierarchy), are managed by controllers using managed objects. To permit fast access to managed objects, a simple circuit with a controller (FLT), a database (DB), and a temporary memory (MEM) is proposed. The controller carries out a method of managing the network element wherein in response to requests (RQ), the objects are stored into the memory and individual objects (MO*) are swapped out to make room for new data according to predeterminal criteria, which specify, for example, the maximum residence time of the object in the memory. At least these objects are transferred to the database (DB). Only upon reception of a request (RQ*) for access to an object (MO*) which is no longer in the memory (MEM) will this object (MO*) be read from the database and transferred back into the memory. The controller manages the network element in response to the requests by accessing the memory and using the objects stored therein.

In digital communications networks, particularly in SDH networks (SDH=Synchronous Digital Hierarchy), a database containing data about the current network configuration is provided for each network element. The network element is managed by a controller using managed objects.

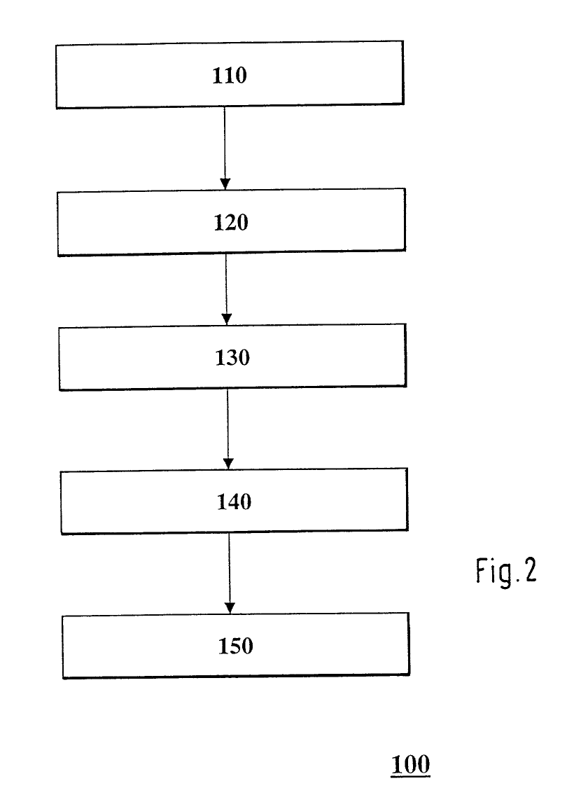

In an article by M. P. Bosse et al entitled “Management von SDH-Netzelementen: eine Anwendung der Informationsmodellierung”, which appeared in “Elektrisches Nachrichtenwesen”, 4th Quarter 1993, a journal published by the applicant, a method and hardware for managing network elements in digital communications networks are described on pages 329 to 338. With reference to FIG. 2 of the article it is described that SDH network elements are managed with the so-called OSI system management (OSI=Open Systems Interconnection). Management is provided by accessing managed objects, which contain all relevant data. On page 332 of the article, the properties of the managed objects as well as elements used for OSI communication, particularly the common management information system element (CMISE), are described. The CMISE supports several services for accessing the managed objects. As shown in FIG. 2 of the article, the network element includes a controller and a database MIB (management information base) connected thereto, whose function is not described, however.

It is an object of the invention to provide a method and apparatus for managing a network element using managed objects. The apparatus is to be simple in construction and to enable fast access to the managed objects needed.

This object is attained by a method with the features according to claim 1 and by a network element and a digital communications network with the features according to the respective independent claims.

Accordingly, in response to a request for access to one of the managed objects, a check is made to determine whether this requested object is stored in the memory. If this requested object is not stored in the memory, a check is made to determine whether there is sufficient memory space to write this object into the memory. If there is no sufficient memory space, at least one of the stored objects is swapped out of the memory to a database in accordance with at least one predeterminable criterion. The requested object is then read from the database and written into the memory.

Thus, individual objects are removed from the memory according to predeterminable criteria in order to make room for new requested objects. The old objects are moved to the database, from where they can be written back into the memory if required. As a result, even large network elements which must have access to a large number of managed objects require only simple, small-capacity memories while all managed objects are still available.

Further advantageous features are defined in the subclaims.

It is particularly advantageous if, based on the criterion, objects which are frequently accessed remain in the memory. In this manner, swap-out and restoring of objects is required as seldom as possible. Particularly frequently needed objects will thus remain in the memory, which can be accessed very fast. Particularly rarely needed objects will remain in the memory only for the duration of the access.

It is also advantageous if only a predeterminable number of recently accessed objects remain in the memory. Thus, the recently very frequently used objects, i.e., the objects which are very likely to be accessed again, remain in the memory.

The predeterminable criterion is advantageously implemented as a filter function, particularly as a CMISE filter function. The filter function indicates which objects are to remain in the memory. Thus, preferably those objects which have particular properties, such as specific names, attributes, or the like, remain in the memory.

The invention will become more apparent from the following description of an embodiment when taken in conjunction with the accompanying drawings, in which:

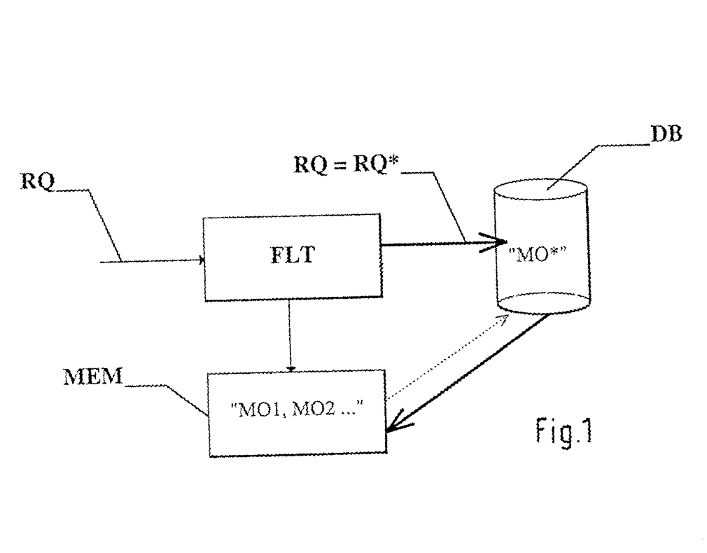

FIG. 1 is a schematic block diagram showing the interconnection of a controller, a database, and a memory for a network element; and

FIG. 2 is a flowchart showing the steps of the method according to the invention.

FIG. 1 shows schematically the interconnection of the following components of a network element for a digital communications network: a controller FLT, a database DB connected thereto, and a memory MEM connected thereto. Both the database DB and the memory MEM serve to store managed objects. The interconnection forms part of a network element (not shown) for an SDH network. Access to the managed objects is obtained via CMISE requests. The memory MEM, which is a fast access semiconductor memory, contains objects MO1 and MO2, for example. The database DB, which is implemented on a hard disk, contains objects swapped out of the memory, for example the object MO*. The controller FLT processes requests RQ for access to the objects.

When a request appears at the input of the controller FLT, the latter will control read and write accesses to the semiconductor memory or the hard disk where the corresponding objects are stored. On application of a request for access to a stored object, such as the object MO2, the controller FLT will control the reading of this object MO2 from memory MEM. On application of a request for access to an object not contained in memory MEM, for example the request RQ* for access to the object MO*, the controller FLT will control the reading of this object MO* from the database DB into the memory.

The controller FLT thus performs a filter function which selects the incoming requests RQ according to whether access to objects in the memory or access to objects no longer or not yet stored in the memory is desired. An additional filter function, particularly the function of a CMISE filter, can be implemented which selects objects based on their properties. Based on attributes, for example, decisions are made as to which objects are to remain in the memory.

The controller FLT further controls the swapping of objects out of the memory MEM to the database DB in order to make room for new objects. Thus, at least the swapped-out objects are stored in the database and remain there for subsequent requests for accesses. It is also possible to use a larger database in which all managed objects are permanently stored. The database DB thus performs a backup function for the memory MEM. If the contents of the memory MEM should be destroyed due to a malfunction, all objects are still available from the database DB.

The operation of the controller FLT will now be described in more detail with reference to FIG. 2, which is a flowchart showing the steps of a method 100 for managing the network element. The method 100 comprises the following steps 110 to 150:

In a first step 110, in response to a request for access to the managed object MO*, a check is made to determine whether this requested object is stored in the memory. If that is not the case, a check is made in a second step 120 to determine whether there is sufficient memory space in the memory.

If that is not the case, in a step 130, stored objects are swapped out of the memory in accordance with predeterminable criteria to make room for the requested object. In this example, the criterion is the frequency of previous accesses to the objects. The most frequently used objects will remain in the memory and will not be swapped out to the database. In this example, a check is made to determine how frequently each of the objects was accessed within a period of half an hour. The frequency is compared with a predetermined minimum. If there is too little memory space, the objects which were accessed with a frequency below the predetermined minimum, i.e., the recently least used objects, will be swapped out of the memory to the database. There is little probability of these objects being used again.

It is also possible to leave only a predeterminable number of those objects in the memory which were recently accessed very often, for example the last ten recently most used objects.

To make room for the requested object MO*, in step 130, the object MO1 shown in FIG. 1, for example, is removed from the memory and written into the database DB, where it can be retrieved for subsequent requests. Thus, less frequently needed objects are swapped out to the database.

In a next step 140, the requested object MO* is transferred from the database DB back into the fast access memory MEM.

In a last step 150, the network element is managed in response to requests (CMISE requests) by accessing the memory and using the objects stored therein. The above-described method can be summarized as follows:

If the requested object MO* is not yet or no longer stored in the memory (step 110), it will be retrieved from the database and, if there is sufficient memory space (step 120), written (back) into the memory (step 140). Otherwise it can be used immediately. If there is no sufficient memory space (step 120), room has to be made by swapping out “old” objects (step 130). Each request is processed by an access to the memory (step 150).

It is also possible to make room for “new” objects in the memory independently of the current usage of the memory, for example at predetermined time intervals. In this manner, the memory is “cleared up” from time to time and sufficient memory space is provided as a precaution.

The invention is particularly suited for use in SDH network elements, particularly in crossconnects.

1. A method (100) of managing a network element using managed objects (MO1, MO2, MO*) wherein the network element is managed in response to requests (RQ) by accessing a memory (MEM) and using the objects (MO1, MO2, MO*) stored therein, said method (100) comprising the steps of:
checking in response to a request (RQ=RQ*) for access to one (MO*) of the managed objects (MO1, MO2, MO*) whether this requested object (MO*) is stored in the memory (MEM) (step 110);
if this requested object (MO*) is not stored in the memory (MEM), checking whether there is sufficient memory space to write this object (MO*) into the memory (MEM) (step 120);
if there is no sufficient memory space, swapping at least one (MO1) of the stored objects (MO1, MO2) out of the memory (MEM) to a database (DB) according to at least one predeterminable criterion (step 130); and reading the requested object (MO*) from the database(DB) and writing it into the memory (MEM) (step 140).

2. A method (100) as claimed in claim 1 wherein based on the criterion, the objects (MO2) which are accessed most frequently remain in the memory (MEM).

3. A method as claimed in claim 2 wherein only a predeterminable number of recently accessed objects remain in the memory.

4. A method as claimed in claim 1 wherein the predeterminable criterion is a filter function, particularly a CMISE filter function, which indicates which objects are to remain stored in the memory.

5. A method as claimed in claim 1 wherein the predeterminable criterion is a length of time which indicates how long each of the objects may remain stored in the memory.

6. A method as claimed in claim 1 wherein the predeterminable criterion is a maximum number which indicates how many objects may remain stored in the memory.

7. A network element for a digital communications network comprising a controller (FLT) for managing the network element using managed objects (MO1, MO2, MO*), a memory (MEM) connected to the controller (FLT), and a database (DB) connected to the controller (FLT), wherein the controller (FLT), in response to requests (RQ), manages the network element by accessing the memory (MEM) and using the objects (MO1, MO2, MO*) stored therein, wherein in response to a request (RQ RQ*) for access to one (MO*) of the managed objects (MO1, MO2, MO*), the controller (FLT) checks whether this requested object (MO*) is stored in the memory, wherein, if this requested object (MO*) is not stored in the memory (MEM), the controller (FLT) checks whether there is sufficient memory space to write this object (MO*) into the memory (MEM), wherein, if there is no sufficient memory space, the controller (FLT) causes at least one (MO1) of the stored objects (MO1, MO2) to be swapped out of the memory (MEM) to a database (DB) according to at least one predeterminable criterion, and wherein the controller (FLT) reads the requested object (MO*) from the database (DB) and writes it into the memory (MEM).

8. A network element as claimed in claim 7 wherein the memory is a semiconductor memory (MEM), and wherein the database (DB) is implemented on a nonvolatile mass storage, particularly on a hard disk.

9. A digital communications network with network elements each comprising a controller (FLT) for managing the network element using managed objects (MO1, MO2, MO*), a memory (MEM) connected to the controller (FLT), and a database (DB) connected to the controller (FLT), wherein the controller (FLT), in response to requests (RQ), manages the network element by accessing the memory (MEM) and using the objects (MO1, MO2, MO*) stored therein, wherein in response to a request (RQ=RQ*) for access to one (MO*) of the managed objects (MO1, MO2, MO*), the controller (FLT) checks whether this requested object (MO*) is stored in the memory, wherein, if this requested object (MO*) is not stored in the memory (MEM), the controller (FLT) checks whether there is sufficient memory space to write this object (MO*) into the memory (MEM), wherein, if there is no sufficient memory space, the controller (FLT) causes at least one (MO1) of the stored objects (MO1, MO2) to be swapped out of the memory (MEM) to a database (DB) according to at least one predeterminable criterion, and wherein the controller (FLT) reads the requested object (MO*) from the database (DB) and writes it into the memory (MEM).

10. A communications network as claimed in claim 9, particularly an SDH network, wherein the network elements are crossconnects, add-drop multiplexers, and/or line multiplexers.
